(19) United States
(12) Patent Application Publication
(10) Pub. No.: US 2015/0162942 A1
(43) Pub. Date: Jun. 11, 2015

(54) POWER CONTROL SCHEME FOR DEVICE TO DEVICE NETWORKS

(71) Applicant: Sony Corporation, Tokyo (JP)

(72) Inventors: Thomas Bolin, Lund (SE); Peter C. Karlsson, Lund (SE); Zhinong Ying, Lund (SE); Erik Bengtsson, Lund (SE)

(73) Assignee: Sony Corporation, Tokyo (JP)

(21) Appl. No.: 14/098,651

(22) Filed: Dec. 6, 2013

(51) Int. Cl. H04B 1/38; H04W 28/02; H04W 52/38

(52) U.S. Cl. CPC H04B 1/3838; H04W 52/383; H04W 28/0221

(57) ABSTRACT

The invention is directed to systems, methods and computer program products for managing device-to-device (D2D) traffic associated with a terminal. An exemplary method comprises: first determining whether the terminal is handling D2D traffic; second determining whether a human body is located either less than or equal to a predetermined distance from the terminal; third determining whether the terminal is receiving power from an external power source; and fourth determining whether to continue handling D2D traffic based on at least one of the second and third determining steps.

### BACKGROUND

Future mobile communication networks will allow for mesh networks to enable device to device (D2D) communication. This means that one user terminal in the network can relay traffic between other terminals in order to offer an extended range of an operator's network. Such a user terminal is referred to as a repeater terminal. Various models can be used to enable such a service. The relay service can run in the background of the terminal while the user is placing a phone call or browsing the Internet on the terminal. The same terminal can also be connected to a WiFi network simultaneously. Occasionally, the terminal can have one or more of its transmitters in operation simultaneously, wherein each transmitter is associated with a different output power. In some network traffic situations, there are risks of excessive power consumption (e.g., power consumption greater than or equal to a threshold power consumption) and excessive radio frequency (RF) near-field exposure level (e.g., exposure level greater than or equal to a threshold exposure level) for the terminal. Therefore, there is a need to address these risks.

### BRIEF SUMMARY

Embodiments of the invention are directed to systems, methods and computer program products for managing D2D traffic associated with a mobile terminal. An exemplary method comprises: first determining whether the terminal is handling D2D traffic; second determining whether a human body is located either less than or equal to a predetermined distance from the terminal; third determining whether the terminal is receiving power from an external power source (DC supply rather than a battery); and fourth determining whether to continue handling D2D traffic based on at least one of the second and third determining steps.

In some embodiments, the second determining step comprises: starting a timer; and monitoring an output power and a channel associated with a transmitter of the terminal.

In some embodiments, the method further comprises calculating a radio frequency (RF) exposure level based on the monitored step and based on accessing a look-up table comprising stored specific absorption rate (SAR) data; and determining whether the RF exposure level is equal to or greater than a predetermined threshold.

In some embodiments, the predetermined threshold comprises 12 Watt-minutes per kilogram.

In some embodiments, the look-up table is stored in the terminal or accessed via a network.

In some embodiments, the terminal is configured to determine whether the terminal is handling infrastructure-based traffic and the fourth determining step comprises determining whether to prioritize the infrastructure-based traffic or the D2D traffic.

In some embodiments, the fourth determining step comprises determining whether to prioritize a phone call or a data transfer.

In some embodiments, the phone call comprises an emergency call or a non-emergency call.

In some embodiments, the method further comprises reducing an output power associated with a transmitter of the terminal, wherein the transmitter is associated with at least one of an emergency call, a non-emergency call, or a data transfer.

In some embodiments, the infrastructure-based traffic comprises a phone call or data transfer.

In some embodiments, the D2D traffic comprises a phone call or data transfer.

In some embodiments, the terminal comprises at least one of a mobile computing device, a non-mobile computing device, a mobile phone, a television, a watch, or a tablet computing device.

In some embodiments, the terminal is in communication with a base station associated with a network.

In some embodiments, the terminal functions as a repeater that enables a second terminal to communicate with a network in communication with the terminal.

In some embodiments, the first, second, third, and fourth determining steps are performed by at least one of the terminal and a network in communication with the terminal.

In some embodiments, the D2D traffic comprises at least one of WiFi traffic or LTE (or cellular) traffic (i.e., associated with a WiFi access point or cellular base station).

In some embodiments, the infrastructure-based traffic comprises at least one of WiFi traffic or LTE (or cellular) traffic (i.e., associated with a WiFi access point or cellular base station).

In some embodiments, an apparatus is provided for managing D2D traffic associated with a mobile terminal. The apparatus comprises: a memory; a processor; and a module stored in the memory, executable by the processor, and configured to: first determine whether the terminal is handling D2D traffic; second determine whether a human body is located either less than or equal to a predetermined distance from the terminal; third determine whether the terminal is receiving power from an external power source; and fourth determine whether to continue handling D2D traffic based on at least one of the second and third determining steps.

In some embodiments, a computer program product is provided for managing D2D traffic associated with a mobile terminal. The computer program product comprises a non-transitory computer-readable medium comprising a set of codes for causing a computer to: first determine whether the terminal is handling D2D traffic; second determine whether a human body is located either less than or equal to a predetermined distance from the terminal; third determine whether the terminal is receiving power from an external power source; and fourth determine whether to continue handling D2D traffic based on at least one of the second and third determining steps.

### BRIEF DESCRIPTION OF THE DRAWINGS

Having thus described embodiments of the invention in general terms, reference will now be made to the accompanying drawings, where:

FIG. 1 is an exemplary network environment for managing D2D traffic associated with a mobile terminal, in accordance with embodiments of the present invention;

FIG. 2 is another exemplary network environment for managing D2D traffic associated with a mobile terminal, in accordance with embodiments of the present invention; and

FIG. 3 is an exemplary process flow for managing D2D traffic associated with a mobile terminal, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to a terminal that provides information to a network that enables the network to control one or more applications being executed on the terminal. Control is achieved with respect to radio frequency (RF) near-field exposure levels and direct current (DC) power drain associated with the terminal. The terminal detects traffic load and human body proximity distances by itself and calculates the RF exposure and battery energy consumed by the terminal, but cannot influence the relaying of traffic requests on its own. In order to prevent the terminal from exhibiting unexpected behavior, there is a need for the terminal to communicate with the host network, wherein the communication comprises information regarding traffic conditions on the network and sensor values (e.g., RF exposure values).

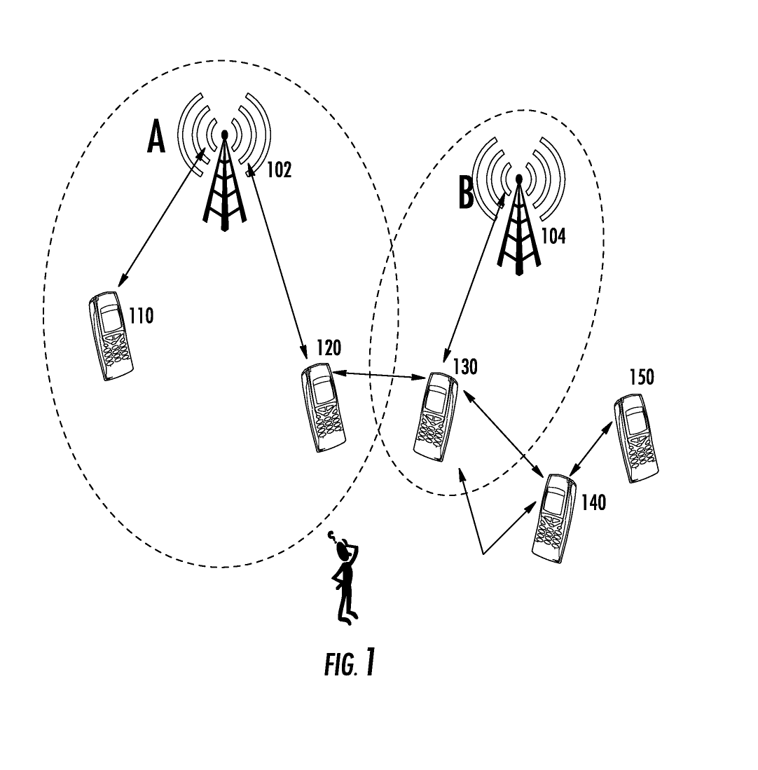

Coming releases of mobile network standards will allow for mobile terminals (e.g., mobile phones) to communicate directly with each other without extensive traffic going via a base station, and will also allow for repeater service between two other mobile terminals (e.g., mobile phones). Referring now to FIG. 1, FIG. 1 displays a network environment comprising a first base station 102, a second base station 104, and five mobile terminals 110, 120, 130, 140, and 150. Base station 102 and terminals 110 and 120 form a first range cell, while base station 104 and terminal 130 form a second range cell. As used herein, a user terminal that relays traffic between other terminals in order to offer an extended range of an operator's network is referred to as a repeater terminal. In FIG. 1, terminals 120, 130, and 140 act as repeat terminals. Terminal 120 provides access for terminal 130 (and terminals 140 and 150) to the network associated with base station 102. Terminal 130 provides access for terminal 120 (and terminals 140 and 150) to the network associated with base station 104. Terminal 140 provides access, via terminal 130, for terminal 150 to the network associated with base station 104.

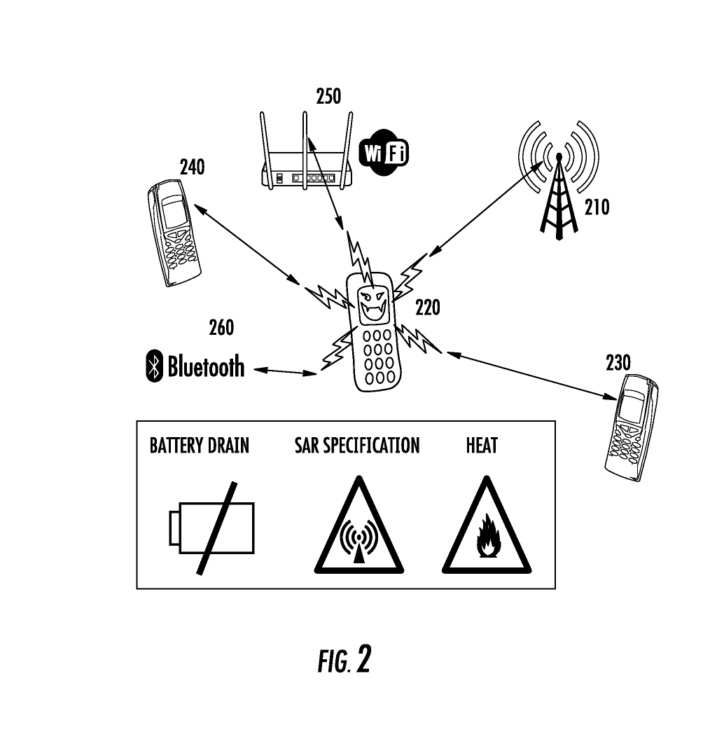

Referring now to FIG. 2, FIG. 2 displays a traffic situation associated with a network environment. The network environment comprises a base station 210, a first mobile device 220, a second mobile device 230, a third mobile device 240, a WiFi enabled device 250, and a Bluetooth enabled device 260. The first mobile device 220 provides repeater service, e.g., access to base station 210 and services or applications associated with the base station 210 to the second mobile device 230, the third mobile device 240, the WiFi enabled device 250, and the Bluetooth enabled device 260.

The mobile device 220 repeater D2D service works on top of the regular cellular network communication (2G/3G/4G or WiFi) with respect to transmitter usage, battery drain, RF exposure, and heat production associated with the mobile device 220. D2D traffic can be offered through Long-term Evolution (LTE) or WiFi or other dedicated radio standards under supervision from the network (e.g., the network base station). This invention enables the base station 210 to assist in limiting the drawbacks with repeater service provided by the mobile device 220.

Embodiments of the invention are directed to systems, methods and computer program products for providing a power control scheme for D2D networks. The present invention is directed to a terminal that relays traffic and enables D2D communication on a mesh network. The present invention ensures that a power source (e.g., a battery) of the terminal is not drained within a short period of time and also ensures that the terminal is not exposed to excessive near-field RF levels just because the terminal is assigned to relay traffic and enable D2D communication on the network. The terminal diverts D2D traffic by itself after notifying the host network (and receiving approval from the host network). The terminal includes at least one human body proximity sensor that outputs the distance between the terminal and the nearest human body. The sensor reading is periodically communicated to the host network either with or without pinging of the terminal by the host network. Based on the sensor reading over a period of time, the terminal determines the allowable utilization of a transmitter of the terminal, and communicates the reading to the host network. The host network determines whether to divert network traffic towards or away from the terminal. Therefore, the host network limits the output power of the terminal without jeopardizing the quality of service provided by the terminal. As used herein, a host network comprises a host network controller.

The following parameters are used to control the amount of network traffic diverted towards or away from a terminal: (1) the number of terminal transmitters in operation at respective frequency bands and output powers associated with the transmitters over a period of time, (2) readings from the terminal proximity sensors over a period of time, (3) readings from a look-up table comprising RF near-field exposure levels with respect to different terminal transmitter conditions, frequency bands, output power values, WiFi combinations, etc., and (4) priority information between the terminal's own traffic and D2D traffic on the network (i.e., which traffic takes precedence over the other). The terminal's own traffic comprises data transmitted or received directly between the terminal and a base station associated with the network. The D2D traffic comprises data transmitted or received, via the terminal, between a second terminal and the base station associated with the network.

The amount of D2D traffic allowed by a terminal needs network control with respect to the following parameters in order to maximize traffic efficiency without jeopardizing specific absorption rate (SAR) regulations: (1) output power and channel versus time of any normal infrastructure-based traffic, (2) output power and channel required to establish D2D traffic, (3) timer tracking if simultaneous infrastructure-based and D2D traffic occurs, (4) status signals from several proximity sensors on the terminal (a proximity sensor can report to the network if the terminal is positioned close to the user's body (e.g., within a predetermined distance of the user's body) or even the distance between a surface of the terminal and the body of the user), (4) input from a look-up table stored in the terminal comprising maximum SAR data with respect to channels and output powers associated with transmitters of the terminal, (5) input from the terminal regarding whether it is direct current (DC) supplied from a charger or not, and (6) optionally, input from a radio temperature sensor (overheat detector) associated with the terminal. Additionally, the terminal stores traffic control priority procedures or obtains the priority procedures from the network in order to handle emergency calls or larger data file transfers via the terminal.

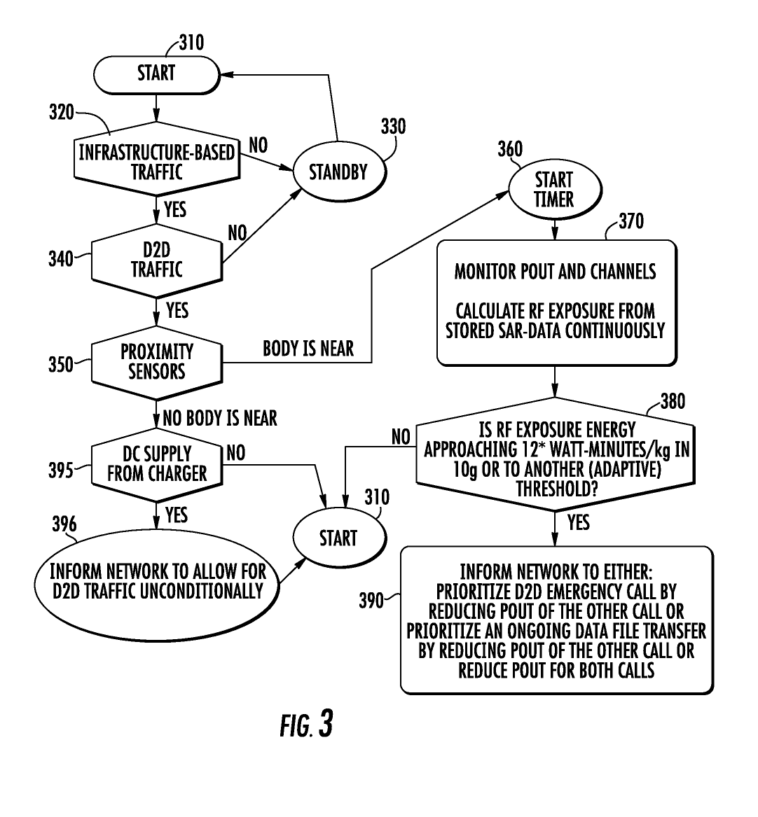

Referring now to FIG. 3, FIG. 3 presents a process flow for managing D2D traffic associated with a mobile terminal. The process flow is performed by the network and/or by the terminal in communication with the network. The process flow starts at block 310. At block 320, the terminal determines whether infrastructure-based traffic is passing through the terminal, and if there is none, the process flow moves to block 330 where the terminal is placed in standby mode. If there is infrastructure-based traffic passing through the terminal, the terminal determines whether there is D2D traffic passing through the terminal at block 340, and if there is none, the process flow moves to block 330 where the terminal is placed in standby mode. At block 350, the terminal determines, using data obtained from one or more proximity sensors associated with the terminal, whether a human body is less than or equal to a predetermined distance from the terminal. If there is no body detected in block 350, the terminal determines whether the terminal is receiving DC supply from a charger at block 395. If yes, the terminal informs the network to allow for D2D traffic to flow unconditionally through the terminal.

At block 350, if the network determines a human body is located at a distance less than or equal to a predetermined distance from the terminal, the terminal starts a timer at block 360. For the duration of the timer, the terminal monitors output powers and channels versus time (for infrastructure-based and/or D2D traffic) associated with one or more transmitters associated with the terminal. At block 370, the terminal calculates the RF exposure based on the monitored information and stored SAR data in the terminal or accessed via the network (look-up table comprising maximum SAR data with respect to channels and output powers associated with transmitters of the terminal). The calculation is performed continuously while the information is monitored. At block 380, the terminal determines whether the RF exposure energy meets or exceeds a particular threshold, which may be adapted from time to time. For example, the terminal determines whether the RF exposure energy approaches 12 Watt-minutes/kg in 10g. The 12 Watt-minute threshold is derived from the SAR standard of maximum average RF exposure of 2 Watt-min/kg for period of 6 minutes. If yes, at block 390, the terminal, for example, informs the network to prioritize the D2D traffic (e.g., an emergency call) by reducing the output power associated with the infrastructure-based traffic (e.g., a second call), or prioritize an ongoing data file transfer through the terminal by reducing the output power of the second call, or by reducing the output power associated with both calls.

The terminal described herein comprises at least one of a mobile computing device, a non-mobile computing device, a mobile phone, a television, a watch, or a tablet computing device. The terminal (and/or base station associated with the network) comprises a processor, a memory, and a module stored in the memory, executable by the processor, and configured to perform the various processes described herein. The processor described herein generally includes circuitry for implementing audio, visual, and/or logic functions. For example, the processor may include a digital signal processor device, a microprocessor device, and various analog-to-digital converters, digital-to-analog converters, and other support circuits. The processor may also include functionality to operate one or more software programs based at least partially on computer-executable program code portions thereof, which may be stored, for example, in a memory.

The memory may include any computer-readable medium. For example, the memory may include volatile memory, such as volatile random access memory (RAM) having a cache area for the temporary storage of information. The memory may also include non-volatile memory, which may be embedded and/or may be removable. The non-volatile memory may additionally or alternatively include an EEPROM, flash memory, and/or the like. The memory may store any one or more of pieces of information and data (e.g., SAR data, etc.).

Any function or process that is described as being performed by the network may be performed by the terminal, and any function or process that is described as being performed by the terminal may be performed by the network. Any function or process that is described as being performed by the network may be performed by the base station associated with the network. The various features described with respect to any embodiments described herein are applicable to any of the other embodiments described herein. Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable information processing apparatus in order to produce a particular machine, such that the one or more computer-executable program code portions, which execute via the processor of the computer and/or other programmable information processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable information processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable information processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for managing device-to-device (D2D) traffic associated with a terminal, the method comprising:
first determining whether the terminal is handling D2D traffic;
second determining whether a human body is located either less than or equal to a predetermined distance from the terminal;
third determining whether the terminal is receiving power from an external power source; and
fourth determining whether to continue handling D2D traffic based on at least one of the second and third determining steps.

2. The method of claim 1, wherein the second determining step comprises:
starting a timer; and
monitoring an output power and a channel associated with a transmitter of the terminal.

3. The method of claim 2, further comprising:
calculating a radio frequency (RF) exposure level based on the monitored step and based on accessing a look-up table comprising stored specific absorption rate (SAR) data; and
determining whether the RF exposure level is equal to or greater than a predetermined threshold.

4. The method of claim 3, wherein the predetermined threshold comprises 12 Watt-minutes per kilogram.

5. The method of claim 3, wherein the look-up table is stored in the terminal or accessed via a network.

6. The method of claim 1, wherein the terminal is configured to determine whether the terminal is handling infrastructure-based traffic, and wherein the fourth determining step comprises determining whether to prioritize the infrastructure-based traffic or the D2D traffic.

7. The method of claim 1, wherein the fourth determining step comprises:
determining whether to prioritize a phone call or a data transfer.

8. The method of claim 7, wherein the phone call comprises an emergency call or a non-emergency call.

9. The method of claim 1, further comprising reducing an output power associated with a transmitter of the terminal, wherein the transmitter is associated with at least one of an emergency call, a non-emergency call, or a data transfer.

10. The method of claim 1, wherein the terminal is configured to determine whether the terminal is handling infrastructure-based traffic, wherein the infrastructure-based traffic comprises a phone call or data transfer.

11. The method of claim 1, wherein the D2D traffic comprises a phone call or data transfer.

12. The method of claim 1, wherein the terminal comprises at least one of a mobile computing device, a non-mobile computing device, a mobile phone, a television, a watch, or a tablet computing device.

13. The method of claim 1, wherein the terminal is in communication with a base station associated with a network.

14. The method of claim 1, wherein the terminal functions as a repeater that enables a second terminal to communicate with a network in communication with the terminal.

15. The method of claim 1, wherein the first, second, third, and fourth determining steps are performed by at least one of the terminal and a network in communication with the terminal.

16. The method of claim 1, wherein the D2D traffic comprises at least one of WiFi traffic or LTE traffic.

17. The method of claim 1, wherein the terminal is configured to determine whether the terminal is handling infrastructure-based traffic, wherein the infrastructure-based traffic comprises at least one of WiFi traffic or LTE traffic.

18. An apparatus for managing device-to-device (D2D) traffic associated with a terminal, the apparatus comprising:
a memory;
a processor; and
a module stored in the memory, executable by the processor, and configured to:
first determine whether the terminal is handling D2D traffic;
second determine whether a human body is located either less than or equal to a predetermined distance from the terminal;
third determine whether the terminal is receiving power from an external power source; and
fourth determine whether to continue handling D2D traffic based on at least one of the second and third determining steps.

19. A computer program product for managing device-to-device (D2D) traffic associated with a terminal, the computer program product comprising:
a non-transitory computer-readable medium comprising a set of codes for causing a computer to:
first determine whether the terminal is handling D2D traffic;
second determine whether a human body is located either less than or equal to a predetermined distance from the terminal;
third determine whether the terminal is receiving power from an external power source; and
fourth determine whether to continue handling D2D traffic based on at least one of the second and third determining steps.
